(19) United States
(12) Patent Application Publication
(10) Pub. No.: US 2007/0051305 A1
(43) Pub. Date: Mar. 8, 2007

(54) Applicator for applying a liquid layer to a passing web

(75) Inventors: Jurgen Heller, Dassendorf (DE); Bernd Stork, Riedstadt (DE)

Correspondence Address: THE FIRM OF KARL F ROSS, 5676 RIVERDALE AVENUE, PO BOX 900, RIVERDALE (BRONX), NY, 10471-0900, US

(73) Assignee: Fleissner GmbH

(21) Appl. No.: 11/516,177

(22) Filed: Sep. 6, 2006

(30) Foreign Application Priority Data
Sep. 6, 2005 (DE) 102005042289.6

(51) Int. Cl. B05C 5/00; B05B 13/02

(52) U.S. Cl. 118/300; 118/325

(57) ABSTRACT

An apparatus for applying a liquid layer to a passing web has a lower flow surface having a lower edge juxtaposed with the web and a first reservoir having an angled downstream surface having an upper edge forming at an upper edge of the lower flow surface a first overflow. A upper flow surface extends upward from adjacent the first overflow, and a second reservoir has an angled downstream surface extending upward to an upper edge forming at an upper edge of the upper flow surface a second overflow. Respective supplies feed liquid to the reservoirs so that the liquid rises therein and flows up the respective downstream surfaces, over the respective overflows, and down the respective flow surfaces, merging on the lower flow surface.

### FIELD OF THE INVENTION

The present invention relates to a liquid applicator. More particularly this invention concerns such an applicator that forms a laminar liquid layer on a passing web.

### BACKGROUND OF THE INVENTION

An apparatus for applying a uniform-thickness liquid layer film in laminar flow to a continuously advancing fabric web across a large working width typically has a first liquid reservoir that is defined by a downstream surface that is directed diagonally upward to the horizontal and extends across the working width, which surface ends in the direction of liquid flow at a first spillover edge or overflow. A guide surface extends at an angle downward from the first overflow edge and has a lower end from which the overflowing liquid film runs off onto the fabric web.

A standard apparatus of this type provides uniform-thickness liquid application on the passing fabric web. Initially, this applies to any amount of dye or other coating liquid to be applied. However, it has been shown that for larger application quantities the pressure of the feed pumps must be so large for the required thick liquid films that there is separation at the overflow edge. The liquid overshoots the overflow edge, and it is no longer possible to apply the liquid evenly across the working width of the guide surface. This problem of the flow being stronger than the effective gravity forces was observed for application volumes between 50 and 200 l/m/min. Of course, this also applies for even greater application volumes.

Therefore, U.S. patent application Ser. No. 10,535,957 provides that the overflow edge or the guide surface is associated with a diverter block that is spaced outward from the overflow edge and that limits the flow rate across the entire length of the working width. This way, the liquid shooting over the overflow edge is slowed, diverted, and forced by the block to flow down the guide surface, with a thickness that is predefined by the adjustable diverter block.

According to U.S. Pat. No. 5,887,459, a divider comb is provided inside the liquid reservoir to calm and homogenize the liquid flowing to the overflow edge. The free ends of this comb can be curved so that they extend across the overflow edge to the plane of the guide surface.

### OBJECTS OF THE INVENTION

It is therefore an object of the present invention to provide an improved applicator for applying a liquid layer to a passing web.

Another object is the provision of such an improved applicator for applying a liquid layer to a passing web that overcomes the above-given disadvantages, in particular that can apply a considerable volume of liquid in an extremely uniform coating or layer.

### SUMMARY OF THE INVENTION

An apparatus for applying a liquid layer to a passing web. The apparatus has according to the invention a lower flow surface having a lower edge juxtaposed with the web and extending a width of the web, a first reservoir extending the width of the web and having an angled downstream surface having an upper edge forming at an upper edge of the lower flow surface a first overflow, first supply means for feeding liquid to the first reservoir so that the liquid rises therein and flows up the downstream surface, over the first overflow, and down the lower flow surface to the web, an upper flow surface extending the width of the web upward from adjacent the first overflow, a second reservoir extending the width of the web and having an angled downstream surface extending upward to an upper edge forming at an upper edge of the upper flow surface a second overflow, and second supply means for feeding liquid to the second reservoir so that the liquid rises therein and flows up the respective downstream surface, over the second overflow, and down the upper flow surface to merge with the flow on the lower flow surface.

This way the liquid film passing over the first overflow edge can be prevented from detaching and spraying with great force to the side. Dividing a liquid film into several partial films that merge at the downstream or first overflow edge, lowers the force of the films and ensures a laminar flow of the partial films across the edge of the advancing fabric web, which films are thereafter united again into a liquid film on the guide surface.

In a preferred embodiment of the apparatus, liquid input ports are provided at the lower ends of the liquid reservoirs provided opposite the overflow edges and the liquid input ports are formed by several liquid inflow openings that are distributed across the working width, which openings in turn are connected to several liquid inflow hoses that are supplied with liquid by a pump.

### BRIEF DESCRIPTION OF THE DRAWING

The above and other objects, features, and advantages will become more readily apparent from the following description, reference being made to the accompanying drawing in which:

FIG. 1 is a cross section through the applicator according to the invention; and

FIG. 2 is a perspective view of the applicator.

### SPECIFIC DESCRIPTION

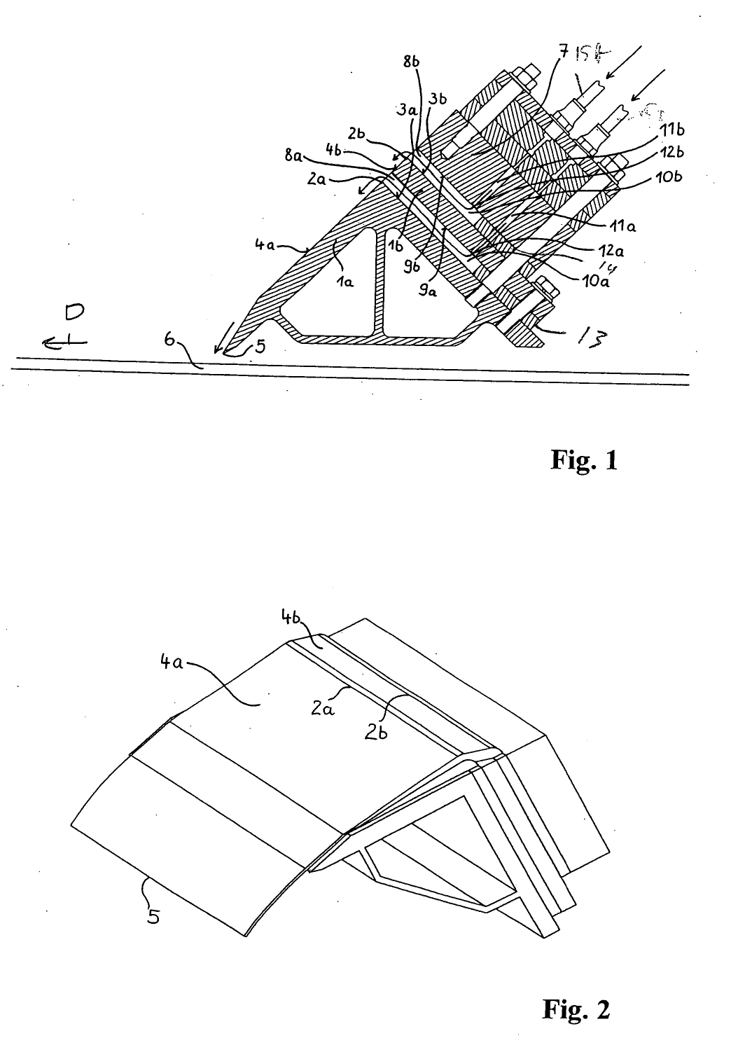

As seen in FIGS. 1 and 2 a liquid applicator has an angled body or beam 1 defining a planar flow surface 4a extending at an angle of about 45° to a horizontal displacement direction D of a moving textile web 6. The surface 4a extends from a lower edge 5 to an upper overflow edge 2a.

A first or lower reservoir 8a has a planar downstream surface 3a extending perpendicular from the surface 4a and meeting same at the overflow edge 2a and a parallel upstream wall 9a defined by a downstream surface of a rectangular-section spacer bar 1b bolted to the beam la and space therefrom by a short spacer bar 13.

A second or upper flow surface 4b coplanar with the surface 4a and also extending a full width (perpendicular to the view plane of FIG. 1) of the workpiece web 6 is formed by an edge of the bar 1b. A second or upper reservoir 8b has a planar downstream surface 3b extending perpendicular from the surface 4b and meeting same at an upper overflow edge 2b and a parallel upstream wall 9b defined by a downstream surface of a rectangular section housing block bolted to the beam la and spaced from the bar 1b by a short spacer bar 14.

Rows of porta 11a and 11b open at lower ro rear ends 10a and 10b of the reservoir chambers 8a and 8b and are connected to respective hoses 14a and 15b forming part of a liquid-supply system that pumps treatment liquid, e.g. dye, into the reservoirs 8a and 8b.

Thus with this system if only a thin film or coating of treatment liquid is to be applied to the web 6, only the lower reservoir 8a is used. The liquid pumped through the supply lines 15a and the ports 11a into the lower end 10a of this reservoir 8a rises therein and flows over the lower overflow edge 2a and then down along the surface 4a to drop as a curtain onto the web 6.

If a thicker layer of treatment liquid is to be applied, for instance at a flow rate of 50 l/m/min (liters per meter of width per minute), the upper reservoir 8b is similarly filled so that liquid therein, which may be the same as the liquid in the reservoir 8a, rises to flow over the upper overflow edge 2b, then flow down over the surface 4b to merge with the flow from the lower reservoir 8a. In this manner flow does not have to be so great from either reservoir 8a or 8b that there is separation at the respective edge 2a or 2b and smooth laminar flow is assured.

We claim:

1. An apparatus for applying a liquid layer to a passing web, the apparatus comprising:
a lower flow surface having a lower edge juxtaposed with the web and extending a width of the web;
a first reservoir extending the width of the web and having an angled downstream surface having an upper edge forming at an upper edge of the lower flow surface a first overflow;
first supply means for feeding liquid to the first reservoir so that the liquid rises therein and flows up the downstream surface, over the first overflow, and down the lower flow surface to the web;
an upper flow surface extending the width of the web upward from adjacent the first overflow;
a second reservoir extending the width of the web and having an angled downstream surface extending upward to an upper edge forming at an upper edge of the upper flow surface a second overflow; and
second supply means for feeding liquid to the second reservoir so that the liquid rises therein and flows up the respective downstream surface, over the second overflow, and down the upper flow surface to merge with the flow on the lower flow surface.

2. The liquid-applying apparatus. defined in claim 1 wherein the upper and lower surfaces are both substantially coplanar.

3. The liquid-applying apparatus defined in claim 1 wherein both of the downstream surfaces are substantially planar and parallel to each other.

4. The liquid-applying apparatus defined in claim 1 wherein both of the supply means have ports opening into lower ends of the respective reservoirs.

5. The liquid-applying apparatus defined in claim 4 wherein each of the supply means has a plurality of the ports spaced along the working width.

6. The liquid-applying apparatus defined in claim 1 wherein each reservoir has an upstream surface substantially parallel to the respective downstream surface.

7. The liquid-applying apparatus defined in claim 1 wherein all of the surfaces extend at an angle of about 45° to a horizontal displacement direction of the web.
